(19) United States
(12) Patent Application Publication
(10) Pub. No.: US 2009/0090688 A1
(43) Pub. Date: Apr. 9, 2009

(54) Color-coded bottle cap cover

(76) Inventor: Michael Fruchter, Cedar Knolls, NJ (US)

Correspondence Address: THOMAS J. GERMINARIO, ESQ., 154 ROUTE 206, CHESTER, NJ, 07930, US

(21) Appl. No.: 11/905,634

(22) Filed: Oct. 3, 2007

(51) Int. Cl. B65D 51/00; B65D 41/02; B31B 1/26; B32B 9/00

(52) U.S. Cl. 215/230; 215/316; 493/162; 428/42.1

(57) ABSTRACT

A color-coded bottle cap cover used to identify the contents and/or ownership of a bottle comprises a peripheral band and an upper lip, such that the bottle cap cover is visible on both the top and side surfaces of the bottle cap.

### BACKGROUND OF THE INVENTION

The present invention relates to a cover that attaches to the cap of a bottle and is color-coded to identify the contents of the bottle and/or the person to whom the bottle belongs.

Since bottles tend to be manufactured in a limited variety of shapes and sizes, there is always the potential for confusing one bottle with another. Such confusion may relate to the owner of the bottle, its contents, or both. The chances of mix-ups increase when a number of people share common facilities at work, school, recreation centers, healthcare facilities, or in the home.

The potential for confusion among similar-looking bottles is particularly problematic with respect to medications, since mistaken use of the wrong medication can have serious adverse health effects. Mistaken appropriation of another person's medicine bottle may also deprive the other person of desperately needed medication. This problem is exacerbated by the nearly uniform cylindrical appearance of standard prescription medication bottles.

In the home, prescription medications for the entire family are often stored in a central location, such as a medicine cabinet, so that their use can be monitored and controlled. While this is a desirable arrangement for purposes of safety and security, it further compounds the problem of misidentification of prescription bottles. When there are a number of prescription bottles on the same shelf, only the bottle caps are readily visible. Therefore, the most effective way of distinguishing different medications and/or the corresponding patient is to add some type of indicator to the bottle cap itself. For ease and certainty of identification, an indicator which employs color-coding is advantageous.

The prior art presents various approaches to color-coded bottle identification. In Humphrey et al., U.S. Pat. No. 4,883,180, the prescription bottle cap and label are both identically color-coded to specify the number of times per day the medicine is to be taken. While the Humphrey invention is useful in terms of reminding the patient of the proper drug dosage, it provides no method for distinguishing different types of medications or identifying the corresponding patient. The color-coding system taught by Humphrey also requires that the pharmacist be supplied with special colored bottle caps and labels, which results in additional expense and inconvenience. Moreover, prescription bottle caps supplied by the pharmaceutical companies often contain indicia identifying the drug manufacturer and/or the product's trade name, so that removing the original cap and replacing it with a color-coded one will in many cases actually make the bottle less readily identifiable.

The alternative to replacing the original prescription bottle cap with a color-coded cap is to affix a color-coded identifier to the original bottle cap. Such an approach is disclosed in Woods, Pub. No. US2004/0216340. In Woods, the cap cover is formed of a die-cut pattern which is folded to provide a peripheral band to surround the vertical edge of the cap and extend horizontally across the top of the cap. The exposed surface of the Woods cap cover contains coloring and printed indicia providing product identification.

The Woods design has two major flaws. First, the Woods cap cover has a top panel which extends from one edge of the peripheral band and is folded over the top of the cap, thereby obscuring the pharmaceutical company's indicia printed or embossed there. Second, the Woods cap cover is secured to the cap simply by the frictional engagement between the inner surfaces of the band and the outer surface of the cap's vertical sides. Such frictional force may be sufficient to hold the cap cover in place when the cap is not being twisted. But even a snuggly fitting die-cut cap cover, without texturing or adhesive on its inner surfaces, will rotate when twisted and will therefore interfere with the removal and replacement of the bottle cap.

In Michaels, Pub. No. US2004/0205989, a bottle labeling system using color-coded elastic bands is disclosed. The color-coded elastic bands are used to identify the day of the week in order to keep track of the freshness of baby formula or pumped breast milk. While Michaels specifies that the elastic bands are placed around the bottle itself, smaller diameter elastic bands could feasibly be applied to bottle caps as well.

The use of Michaels-type colored elastic bands as identifiers on prescription bottle caps has two significant disadvantages which renders them not particularly suited for this purpose. First, the elastic band covers only the cap's vertical edge. In a cluttered medical cabinet, the vertical edge of the bottle cap is often obscured by surrounding bottles. Therefore, it is highly advantageous to have a colored identifier that is also visible on the top of the cap, which is something that a simple elastic band cannot provide. Second, the elasticity of natural and synthetic elastomers is known to degrade through oxidation over time. Such degradation leads to brittleness and cracking, and it is accelerated by heat, humidity and fluorescent lighting—all of which are prevalent in a bathroom environment where medicines are typically stored. The effects of elastomer degradation are also compounded by the twisting of the elastic band each time the cap to which it's attached is screwed on or off.

Color-coded flexible plastic disks that can be slipped around a bottle's neck are disclosed in Eberl et al., Pub. No. US2005/0235532, and Cope et al., Pub. No. US2006/0283059. But both of these designs depend upon a tapered bottle neck to hold the disk in place, and neither would remain attached to a cylindrical bottle or bottle cap.

Consequently, the prior art does not teach a color-coded bottle cap cover in which the colored identification is visible on the top of the cap but does not obscure the indicia already present there. The prior art also fails to disclose a bottle cap cover that will not interfere with screwing the cap on and off and/or will not significantly degrade under the twisting force associated with cap removal and replacement. The present invention, on the other hand, provides a color-coded cap cover which fulfills these criteria and is particularly suited to the task of distinguishing different prescription medicine bottles.

### SUMMARY OF THE INVENTION

An object of the present invention is to provide a color-coded bottle identifier that is visible on both the top and sides of the bottle cap but does not require replacement of the original bottle cap.

Another object of the present invention is to provide a color-coded bottle cap cover that is visible on both the top and sides of the bottle cap but does not cover or obscure any portion of the indicia printed or embossed on the top of the bottle cap.

A further object of the present invention is to provide a color-coded bottle cap cover that does not rotate as the bottle cap is twisted when the cap is being removed or replaced.

Yet another object of the present invention is to provide a color-coded bottle cap cover that can withstand repeated twisting during removal and replacement of the bottle cap.

Yet a further object of the present invention is to provide a color-coded bottle cap cover that is inexpensive, simple, convenient and easy to use.

Still another object of the present invention is to provide a color-coded bottle cap cover that is particularly suited to the task of distinguishing different prescription medicine bottles in terms of the specific medication contained in the bottle, the category of the medication (e.g., cardiac, erectile dysfunction, anti-depressant, etc.), and/or the patient to when the medication is prescribed.

These and other beneficial objects are achieved by a bottle cap cover that is designed to be attached to a bottle cap having a substantially flat disk-shaped top surface and a substantially vertical side surface. The side surface is a cylindrical flange depending downward from the circumference of the top surface. The bottle cap cover comprises a peripheral band and an upper lip.

The peripheral band of the cap cover is a cylindrical structure conforming to the shape of the cap's side surface but having a slightly larger diameter, such that the peripheral band slides snuggly over the cap's side surface. The width of the peripheral band is preferably not greater than the width of the cap's side surface and not less than half the width of the cap's side surface.

The upper lip of the cap cover is a flat annular flange extending radially inward from the top circumference of the peripheral band, such that when the entire width of the peripheral band extends over the cap's side surface, the upper lip engages the entire circumference of the cap's top surface. The width of the upper lip is preferably not less than 10% and not more than 20% of the diameter of the cap's top surface.

In order to prevent the cap cover from rotating over the cap when the cap is twisted, the present invention includes three alternate embodiments, which may be applied singly or in combination. Option A is to make the width of the peripheral band approximately half the width of the cap's side surface, so that the bottom half of the cap's side surface can be gripped when twisting the cap. Option B is to provide texturing on the inner surface of the peripheral band. Such texturing can consist of vertical serrations and/or ridges which tractionally engage the outer surface of the cap's side surface. Option C is to include a self-adhesive layer on all or portions of the inner surface of the peripheral band and/or on the under surface of the upper lip.

Regarding the fabrication of the cap cover, there are two alternate preferred embodiments of the present invention. In Alternate 1, the cap cover is made of integrally molded plastic. In Alternate 2, the cap cover is formed from a self-adhesive pattern, which optimally is fabricated from a flexible plastic, such as 3 to 6 mils vinyl, with a self-adhesive backing. The self-adhesive pattern comprises a peripheral strip, a plurality of trapezoidal teeth and a connective tab. The peripheral strip is a rectangular strip from which upwardly project the trapezoidal teeth, all of which are identical trapezoids. The peripheral strip has a length equal to the circumference of the cap's side surface, and the peripheral strip joins on its distal end with the connective tab. The peripheral strip, the trapezoidal teeth and the connective tab have a self-adhesive backing.

In forming in cap cover pursuant to Alternate 2, the peripheral strip is wrapped around the cap's side surface, to which its self-adhesive backing adheres, and its proximal and distal ends are joined together by the connective tab. The trapezoidal teeth are then bent perpendicularly inward so as to extend horizontally over and upon the cap's top surface, to which the self-adhesive backing of the trapezoidal teeth adheres. The trapezoidal teeth are configured so that, when they are all bent perpendicularly over the cap's top surface, their oblique sides conjoin to form a continuous flat annular flange extending perpendicularly inward from the top circumference of the peripheral strip. As a result of this procedure, the peripheral strip forms the peripheral band of the cap cover, and the conjoined trapezoidal teeth form the upper lip.

In the color-coding of the cap cover, single solid colors as well as multi-colored patterns can be used. The color coding of the cap cover can be utilized in many ways to provide identification relating to the contents of the bottle or the person(s) to whom the bottle belongs or to whose use it has been assigned. For example, the color coding can identify the specific contents of the bottle, or the generic type of contents, or an expiration date of the contents, or the individual who is to use of consume the contents. For instance, each member of a family might be assigned a color or a multi-colored pattern, so that the color of the cap cover would identify the medicine, vitamins, etc. of each family member. In another exemplary scenario, a single individual might designate different colors and/or multi-colored patterns to identify his or her various medications.

### BRIEF DESCRIPTION OF THE DRAWINGS

FIG. 1 is a perspective view of the Alternate 1 embodiment of the present invention affixed to a prescription medicine bottle.

FIG. 2 is a plan view of the Alternate 2 embodiment of the present invention.

### DETAILED DESCRIPTION OF THE PREFERRED EMBODIMENTS

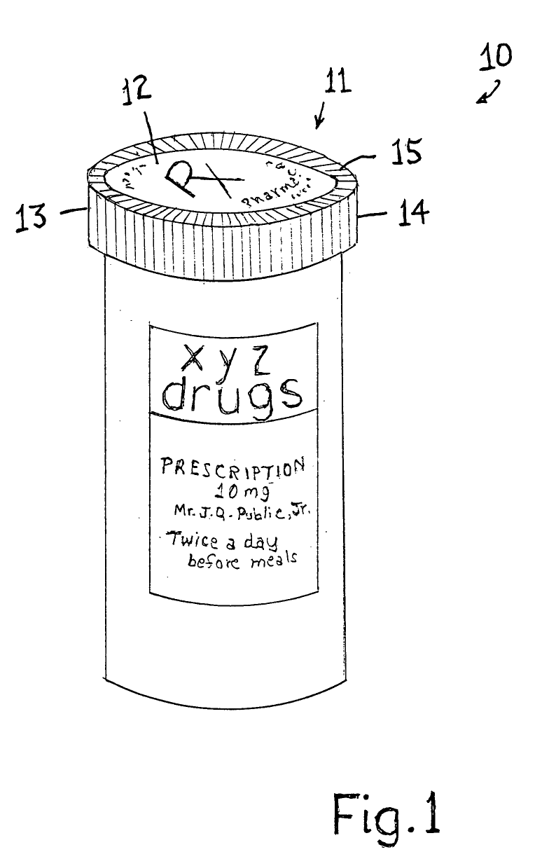

Referring to FIG. 1, a bottle cap cover according to the present invention 10 is designed to be attached to a bottle cap 11 having a substantially flat disk-shaped top surface 12 and a substantially vertical side surface 13. The side surface 13 is a cylindrical flange depending downward from the circumference of the top surface 12. The bottle cap cover 10 comprises a peripheral band 14 and an upper lip 15.

The peripheral band 14 of the cap cover 10 is a cylindrical structure conforming to the shape of the cap's side surface 13 but having a slightly larger diameter, such that the peripheral band 14 slides snuggly over the cap's side surface 13. The width of the peripheral band 14 is preferably not greater than the width of the cap's side surface 13 and not less than half the width of the cap's side surface 13.

The upper lip 15 of the cap cover is a flat annular flange extending radially inward from the top circumference of the peripheral band 14, such that when the entire width of the peripheral band 14 extends over the cap's side surface 13, the upper lip 15 engages the entire circumference of the cap's top surface 12. The width of the upper lip 15 is preferably not less than 10% and not more than 20% of the diameter of the cap's top surface 12.

In order to prevent the cap cover 10 from rotating over the cap 11 when the cap 11 is twisted, the present invention 10 includes three alternate embodiments, which may be applied singly or in combination. Option A is to make the width of the peripheral band 14 approximately half the width of the cap's side surface 13, so that the bottom half of the cap's side surface 13 can be gripped when twisting the cap 11. Option B is to provide texturing on the inner surface of the peripheral band 14. Such texturing can consist of vertical serrations and/or ridges which tractionally engage the outer surface of the cap's side surface 13. Option C is to include a self-adhesive layer on all or portions of the inner surface of the peripheral band 14 and/or on the under surface of the upper lip 15.

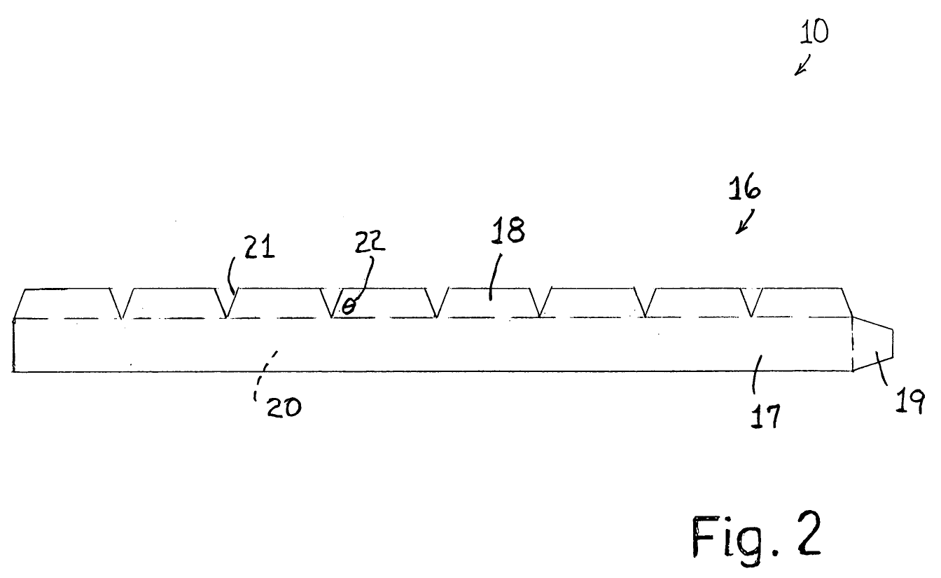

Regarding the fabrication of the cap cover 10, there are two alternate preferred embodiments of the present invention 10. In Alternate 1, as shown in FIG. 1, the cap cover 10 is made of integrally molded plastic. In Alternate 2, as depicted in FIG. 2, the cap cover 10 is formed from a self-adhesive pattern 16, which optimally is fabricated from a flexible plastic, such as 3 to 6 mils vinyl, with a self-adhesive backing. The self-adhesive pattern 16 comprises the peripheral strip 17, a plurality of trapezoidal teeth 18 and a connective tab 19. The peripheral strip 17 is a rectangular strip from which upwardly project the trapezoidal teeth 18, all of which are identical trapezoids. The peripheral strip 17 has a length equal to the circumference of the cap's side surface 13, and the peripheral strip 17 joins on its distal end with the connective tab 19. The peripheral strip 17, the trapezoidal teeth 18 and the connective tab 19 have a self-adhesive backing 20.

In forming in cap cover 10 pursuant to Alternate 2, the peripheral strip 17 is wrapped around the cap's side surface 12, to which its self-adhesive backing 20 adheres, and its proximal and distal ends are joined together by the connective tab 19. The trapezoidal teeth 18 are then bent perpendicularly inward so as to extend horizontally over and upon the cap's top surface 12, to which the self-adhesive backing 20 of the trapezoidal teeth 18 adheres. The trapezoidal teeth 18 are configured so that, when they are all bent perpendicularly over the cap's top surface 12, their oblique sides 21 conjoin to form a continuous flat annular flange extending perpendicularly inward from the top circumference of the peripheral strip 17. As a result of this procedure, the peripheral strip 17 forms the peripheral band 14 of the cap cover 10, and the conjoined trapezoidal teeth 18 form the upper lip 15.

In order for the trapezoidal teeth 18 to conjoin to form the continuous flange of the upper lip 15, the trapezoidal teeth 18 must have a specific geometry. The base angles θ 22 of each of the trapezoidal teeth 18 must have a tangent equal to N, which is the number of trapezoidal teeth 18, divided by π (3.1416), in accordance with the formula: θ=arctan N/π.

In FIG. 2, for example, there are 8 trapezoidal teeth 18, so the base angles θ 22 must all be equal to the arctangent of 8÷π, which is 68.56°.

While the present invention has been described in terms of several preferred embodiments, it will be apparent to those skilled in the art that various other embodiments of the present invention are feasible, all of which are intended to be encompassed by the claims appended hereto.

What is claimed is:

1. A bottle cap cover, attachable to a cylindrical bottle cap having a side surface and a top surface, the bottle cap cover comprising:
(a) a peripheral band, which is a cylindrical structure conforming to the shape of the side surface of the bottle cap, which peripheral band has an inner surface sized so as to fit snuggly over the side surface of the bottle cap, and which peripheral band is color-coded so as to identify the contents, ownership or custody of a bottle sealed by the bottle cap; and
(b) an upper lip color-coded consistently with the peripheral band, which upper lip is a flat annular flange extending radially inward from the top circumference of the peripheral band and having a width less than the radius of the top surface of the bottle cap, such that when the bottle cap cover is attached to the bottle cap, the upper lip engages the entire circumference of the top surface of the bottle cap but does not extend to the center of the top surface of the bottle cap.

2. The bottle cap cover according to claim 1, wherein the width of the peripheral band is not greater than the width of the side surface of the bottle cap and not less than half the width of the side surface of the bottle cap.

3. The bottle cap cover according to claim 2, wherein the width of the upper lip is not less than 10% and not more than 20% of the diameter of the top surface of the bottle cap.

4. The bottle cap cover according to claim 3, wherein the width of the peripheral strip is approximately half the width of the side surface of the bottle cap, such that the bottom half of the side surface remains exposed and can be gripped when the cap is being twisted.

5. The bottle cap cover according to either of claims 3 or 4, wherein all or portions of the inner surface of the peripheral band is textured with serrations and/or ridges, such that the inner surface of the peripheral band tractionally engages the side surface of the bottle cap, such that a twisting force applied to the peripheral band is effectively transmitted to the bottle cap.

6. The bottle cap cover according to either of claims 3 or 4, wherein all or portions of the inner surface of the peripheral band and/or the under surface of the upper lip have a self adhesive layer, such that a twisting force applied to the peripheral band is effectively transmitted to the bottle cap.

7. A self-adhesive pattern for forming a bottle cap cover, attachable to a cylindrical bottle cap having a side surface and a top surface, the self-adhesive pattern comprising:
(a) a peripheral strip, which is a rectangular strip of flexible plastic having a proximal end and a distal end, and having a length equal to the circumference of the side surface of the bottle cap, and having a width less than or equal to the width of the side surface of the bottle cap, and having a self-adhesive backing, which peripheral strip is color-coded so as to identify the contents, ownership or custody of a bottle sealed by the bottle cap;
(b) a plurality of trapezoidal teeth projecting upward from the peripheral strip and having a self-adhesive backing, which trapezoidal teeth are color-coded consistently with the peripheral band, and which trapezoidal teeth are all in the shape of a trapezoid having a base and two base angles θ, wherein the base of the trapezoid has a length equal to the length of the peripheral strip divided by the number N of trapezoidal teeth, and wherein the two base angles θ of the trapezoid are each equal to the arctangent of the quantity (N÷π); and
(c) a connective tab joined to the distal end of the peripheral strip, which connective tab has a self-adhesive backing.

8. A method of forming a bottle cap cover and attaching the bottle cap cover to a cylindrical bottle cap having a side surface and a top surface, comprising:
(a) providing a self-adhesive pattern comprising: (1) a peripheral strip, which is a rectangular strip of flexible plastic having a proximal end and a distal end, and having a length equal to the circumference of the side surface of the bottle cap, and having a width less than or equal to the width of the side surface of the bottle cap, and having a self-adhesive backing, which peripheral strip is color-coded so as to identify the contents, ownership or custody of a bottle sealed by the bottle cap; (2) a plurality of trapezoidal teeth projecting upward from the peripheral strip and having a self-adhesive backing, which trapezoidal teeth are color-coded consistently with the peripheral band, and which trapezoidal teeth are all in the shape of a trapezoid having a base and two base angles θ, wherein the base of the trapezoid has a length equal to the length of the peripheral strip divided by the number N of trapezoidal teeth, and wherein the two base angles θ of the trapezoid are each equal to the arctangent of the quantity (N÷π); and (3) a connective tab joined to the distal end of the peripheral strip, which connective tab has a self-adhesive backing;
(b) wrapping the peripheral strip completely around the side surface of the bottle cap, so that the self-adhesive backing secures the peripheral strip to the side surface of the bottle cap;
(c) joining the distal end of the peripheral strip to the proximal end using the connective tab;
(d) bending the trapezoidal teeth perpendicularly inward so as to extend over and upon the top surface of the bottle cap, so that the self-adhesive backing secures the trapezoidal teeth to the top surface of the bottle cap, and such that the trapezoidal teeth conjoin to form a continuous flat annular flange extending perpendicularly inward toward the center of the top surface of the bottle cap from the top circumference of the peripheral strip; and
(e) producing, as a result of the foregoing steps, a configuration in which the peripheral strip forms a peripheral band of the bottle cap cover and the conjoined trapezoidal teeth form an upper lip of the bottle cap cover.
